(19) United States
(12) Patent Application Publication
(10) Pub. No.: US 2008/0028188 A1
(43) Pub. Date: Jan. 31, 2008

(54) TIME DE-INTERLEAVER IMPLEMENTATION USING SDRAM IN A TDS-OFDM RECEIVER

(75) Inventor: Yan Zhong, San Jose, CA (US)

Correspondence Address: FRANK F. TIAN, 331-4A THIRD AVENUE, LONG BEACH, NJ, 07740, US

(73) Assignee: LEGEND SILICON, FREMONT, CA (US)

(21) Appl. No.: 11/677,225

(22) Filed: Feb. 21, 2007

Related U.S. Application Data
(60) Provisional application No. 60/820,319, filed on Jul. 25, 2006.

(51) Int. Cl. G06F 9/30

(52) U.S. Cl. 712/200

(57) ABSTRACT

A receiver having an apparatus having a processor for processing interleaved data; and an independent memory coupled to the processor for processing the interleaved data is provided.

### REFERENCE TO RELATED APPLICATIONS

This application claims an invention which was disclosed in Provisional Application No. 60/820,319, filed Jul. 25, 2006 entitled “Receiver for An LDPC based TDS-OFDM Communication System”. The benefit under 35 USC §119(e) of the United States provisional application is hereby claimed, and the aforementioned application is hereby incorporated herein by reference.

### FIELD OF THE INVENTION

The present invention relates generally to de-interleavers. More specifically, the present invention relates to a time de-interleaver implementation using Synchronous Dynamic Random Access Memory (SDRAM) in a Time Domain Synchronous Orthogonal Frequency Division Multiplexing (TDS-OFDM) receiver.

### BACKGROUND

Synchronous Dynamic Random Access Memory (SDRAM) are known. Typically a SDRAM is a type of solid state memory device having a synchronous interface waiting for a clock signal before responding to received control inputs such as controls coming from a processor. The clock is typically used to drive an internal finite state machine that pipelines incoming instructions. Pipelining facilitates the acceptance of a new instruction before the previous d processing is finished. In a pipelined write, the write command can be immediately followed by another instruction without waiting for the data to be written to the memory array. In a pipelined read, the requested data appears a fixed number of clock pulses after the read instruction. This delay is called the latency and is an important parameter to be considered when purchasing SDRAM for a computer. In other words, it is not necessary to wait for the data to appear before sending the next instruction

Using SDRAM in a receiver is known. United States published patent application No. 20050251726 to Takamura, Mototsugu discloses a deinterleave device, and deinterleave method wherein a decoder has a packet de-interleaver for performing folding de-interleaving, in units of a packet, on packet interleave data (PID) and a byte de-interleaver for performing folding de-interleaving, in units of a byte, on byte interleave data (BID) generated by this packet de-interleaver. It is thus possible to correct a significant burst error containing a packet loss even with an error correction code having a very small code length.

Typically for a Time domain synchronous-Orthogonal frequency-division multiplexing (TDS-OFDM) receiver, time-deinterleaver is used to increase its resilience in its ability to withstand spurious noise. For example, a typical time-deinterleaver with a convolutional de-interleaver needs a memory with size B*(B−1)*M/2 where B is the number of the branch, and M is the depth. Since the required time-deinterleaver length is generally very long, therefore instead of using a large on-chip memory, it is desirous to use a cost-effective stand alone or commercially available SDRAM chip for storing the data.

### SUMMARY OF THE INVENTION

A Time-Deintleaver having a stand alone or commercially available SDRAM chip for processing interleaved signals is provided.

In a TDS-OFDM receiver, a stand alone or commercially available SDRAM chip is provided for storing the data associated with a time-deinterleaver.

In a TDS-OFDM communications system, receiver having an apparatus having a processor for processing interleaved data; and an independent memory coupled to the processor for processing the interleaved data is provided.

In a TDS-OFDM communications system, a apparatus comprising: a processor for processing interleaved data; and an independent memory coupled to the processor for processing the interleaved data is provided.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a receiver in accordance with some embodiments of the invention.

FIG. 2A is a first example of a set of sechemes in accordance with some embodiments of the invention.

FIG. 2B is a second example of a set of sechemes in accordance with some embodiments of the invention.

FIG. 3 is an example of a de-interleaver in accordance with some embodiments of the invention.

FIG. 4 is an example of a more detailed depiction of the de-interleaver of FIG. 3 in accordance with some embodiments of the invention.

FIG. 5 is an example of a flowchart in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a time-deintleaver having a stand alone or commercially available SDRAM chip for processing interleaved signals. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of a time-deintleaver having a stand alone or commercially available SDRAM chip for processing interleaved signals described herein. The non-processor circuits may include, but are not limited to, a radio receiver, a radio transmitter, signal drivers, clock circuits, power source circuits, and user input devices. As such, these functions may be interpreted as steps of a method to perform time-deintleaving using a stand alone or commercially available SDRAM chip for processing interleaved signals. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

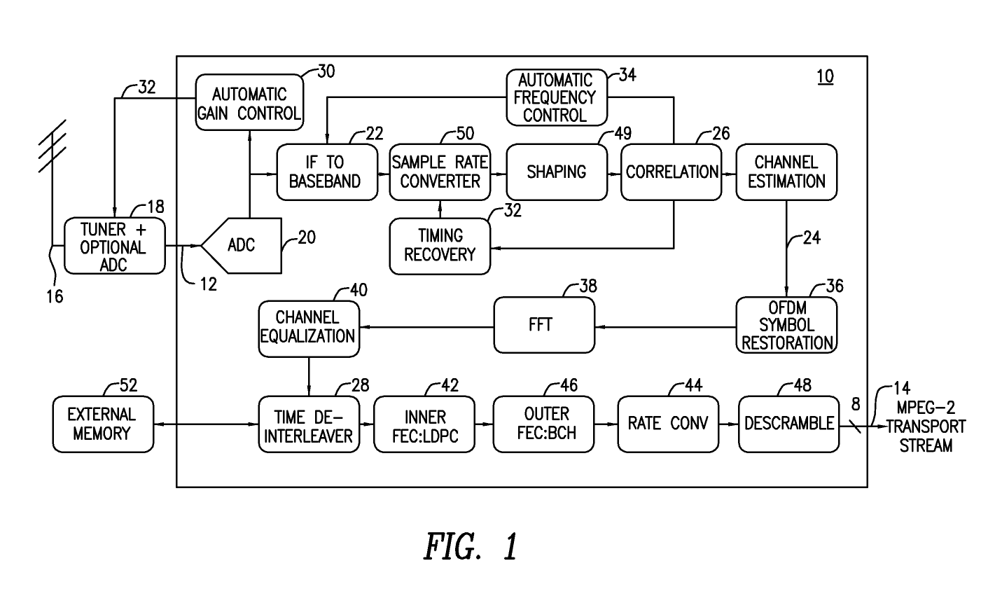

Referring to FIG. 1, a receiver 10 for implementing a LDPC based TDS-OFDM communication system is shown. In other words, FIG. 1 is a block diagram illustrating the functional blocks of an LDPC based TDS-OFDM receiver 10. Demodulation herein follows the principles of TDS-OFDM modulation scheme. Error correction mechanism is based on LDPC. The primary objectives of the receiver 10 is to determine from a noise-perturbed system, which of the finite set of waveforms have been sent by a transmitter and using an assortment of signal processing techniques to reproduce the finite set of discrete messages sent by the transmitter.

The block diagram of FIG. 1 illustrates the signals and key processing steps of the receiver 10. It is assumed that the input signal 12 to the receiver 10 is a down-converted digital signal. The output signal 14 of receiver 10 is a MPEG-2 transport stream. More specifically, the RF (radio frequency) input signals 16 are received by an RF tuner 18 where the RF input signals are converted to low-IF (intermediate frequency) or zero-IF signals 12. The low-IF or zero-IF signals 12 are provided to the receiver 10 as analog signals or as digital signals (through an optional analog-to-digital converter 20).

In the receiver 10, the IF signals are converted to base-band signals 22. TDS-OFDM demodulation is then performed according to the parameters of the LDPC (low-density parity-check) based TDS-OFDM modulation scheme. The output of the channel estimation 24 and correlation block 26 is sent to a time de-interleaver 28 and then to the forward error correction (FEC) block. The output signal 14 of the receiver 10 is a parallel or serial MPEG-2 transport stream including valid data, synchronization and clock signals. The configuration parameters of the receiver 10 can be detected or automatically programmed, or manually set. The main configurable parameters for the receiver 10 include: (1) Sub carrier modulation type including: QPSK, 16QAM, 64QAM; (2) FEC rate including: 0.4, 0.6 and 0.8; (3) Guard interval having: 420 or 945 symbols; (4) Time de-interleaver mode including three modes respectively having: 0, 240 or 720 symbols; (5) Control frames detection; and (6) Channel bandwidth including: 6, 7, or 8 MHz.

The functional blocks of the receiver 10 are described as follows.

Automatic gain control (AGC) block 30 compares the input digitized signal strength with a reference. The difference is filtered and the filter value 32 is used to control the gain of the amplifier 18. The analog signal provided by the tuner 12 is sampled by an ADC 20. The resulting signal is centered at a lower IF. For example, sampling a 36 MHz IF signal at 30.4 MHz results in the signal centered at 5.6 MHz. The IF to Baseband block 22 converts the lower IF signal to a complex signal in the baseband. The ADC 20 uses a fixed sampling rate. Conversion from this fixed sampling rate to the OFDM sample rate is achieved using the interpolator in block 22. The timing recovery block 32 computes the timing error and filters the error to drive a Numerically Controlled Oscillator (not shown) that controls the sample timing correction applied in the interpolator of the sample rate converter.

There can be frequency offsets in the input signal 12. The automatic frequency control block 34 calculates the offsets and adjusts the IF to baseband reference IF frequency. To improve capture range and tracking performance, frequency control is done in two stages: a coarse stage and a fine stage. Since the transmitted signal is square root raised cosine filtered, the received signal will be applied with the same function. It is known that signals in a TDS-OFDM system include a PN sequence preceding the IDFT symbol. By correlating the locally generated PN with the incoming signal, it is easy to find the correlation peak (so the frame start can be determined) and other synchronization information such as frequency offset and timing error. Channel time domain response is based on the signal correlation previously obtained. Frequency response is taking the FFT of the time domain response.

In TDS-OFDM, a PN sequence replaces the traditional cyclic prefix. It is thus necessary to remove the PN sequence and restore the channel spreaded OFDM symbol. Block 36 reconstructs the conventional OFDM symbol that can be one-tap equalized. The FFT block 38 performs a fixed point FFT such as a 3780 point FFT. Channel equalization 40 is carried out from the FFT 38 transformed data based on the frequency response of the channel. De-rotated data and the channel state information are sent to FEC for further processing.

In the TDS-OFDM receiver 10, the time-deinterleaver 28 is used to increase the resilience to spurious noise. The time-deinterleaver 28 is a convolutional de-interleaver which needs a memory with size B*(B−1)*M/2, where B is the number of the branch, and M is the depth. For the TDS-OFDM receiver 10 of the present embodiment, there are three modes of time-deinterleavering. For mode 1 B=52, M=48, mode 2 B=52, M=240, and for mode 3, B=52, M=720.

The LDPC decoder 42 is a soft-decision iterative decoder for decoding, for example, a Quasi-Cyclic Low Density Parity Check (QC-LDPC) code provided by a transmitter (not shown). LDPC decoder 42 is configured to decode at 3 different rates (i.e. rate 0.4, rate 0.6 and rate 0.8) of QC_LDPC codes by sharing the same piece of hardware. The iteration process is either stopped when it reaches the specified maximum iteration number (full iteration), or when the detected error is free during error detecting and correcting process (partial iteration).

The TDS-OFDM modulation/demodulation system is a multi-rated system based on multiple modulation schemes (e.g. QPSK, 16QAM, 64QAM), and multiple coding rates (0.4, 0.6, and 0.8), where QPSK stands for Quad Phase Shift Keying and QAM stands for Quadrature Amplitude Modulation. The output of BCH decoder 46 is bit by bit. According to different modulation schemes and coding rates, the rate conversion block 44 combines the bit output of BCH decoder 46 to bytes, and adjusts the speed of byte output clock to make the receiver 10's MPEG packets outputs evenly distributed during the whole demodulation/decoding process.

The BCH decoder 46 is designed to decode codes such as BCH (762, 752) code, which is the shortened binary BCH code of BCH (1023, 1013). The generator polynomial is x̂10+x̂3+1.

Since the data in the transmitter has been randomized using a pseudo-random (PN) sequence before BCH encoder (not shown), the error corrected data by the LDPC/BCH decoder 46 must be de-randomized. The PN sequence is generated by the polynomial 1+x¹⁴+x¹⁵, with initial condition of 100101010000000. The de-scrambler/de-randomizer 48 will be reset to the initial condition for every signal frame. Otherwise, de-scrambler/de-randomizer 48 will be free running until reset again. The least significant 8-bit will be XORed with the input byte stream.

The data flow through the various blocks of the modulator is as follows. The received RF information 16 is processed by a digital terrestrial tuner 18 which picks the frequency bandwidth of choice to be demodulated and then downconverts the signal 16 to a baseband or low-intermediate frequency. This downconverted information 12 is then converted to the Digital domain through an analog-to-digital data converter 20.

The baseband signal after processing by a sample rate converter 50 is converted to symbols. The PN information found in the guard interval is extracted and correlated with a local PN generator to find the time domain impulse response. The FFT of the time domain impulse response gives the estimated channel response. The correlation 26 is also used for the timing recovery 32 and the frequency estimation and correction of the received signal. The OFDM symbol information in the received data is extracted and passed through a 3780 FFT 38 to obtain the symbol information back in the frequency domain. Using the estimated channel estimation previously obtained, the OFDM symbol is equalized and passed to the FEC decoder.

At the FEC decoder, the time-deinterleaver block 28 performs a deconvolution of the transmitted symbol sequence and passes the 3744 blocks to the inner LDPC decoder 42. The LDPC decoder 42 and BCH decoders 46 which run in a serial manner take in exactly 3780 symbols, remove the 36 TPS symbols and process the remaining 3744 symbols and recover the transmitted transport stream information. The rate conversion 44 adjusts the output data rate and the de-randomizer 48 reconstructs the transmitted stream information. An external memory 52 coupled to the receiver 10 provides memory thereto on a predetermined or as needed basis. It is noted that alternatively the 36 TPS symbols can be removed before time-deinterleaver 28,

In an embodiment, the 36 TPS symbols should be removed before processed by time-deinterleaver. The number of symbols in each frame should be multiple of 52 (parameter B) for easy frame synchronization. The number 3744 is the multiple of 52, not 3780.

A SDRAM, typically available from a SDRAM provider, is elected in a preferred embodiment of the present invention. Based on the specific SDRAM chip requirement, this invention creates an innovative or novel partition, access, and read/write scheduling strategy for the memory. This strategy not only satisfies all the SDRAM application requirements, but also uses the memory very efficiently.

An Introduction to Time-Deinterleaver

Since on the transmitter side, time-interleaver module is used after FEC (forward error correction), but before FFT (fast Fourier transform). And it only functions on 3744 FEC encoded symbols, on the receiver side, Time-Deinterleaver 28 is inserted after FFT module 38 but before the LDPC (low density parity check) block 42 and block 46. it should be noted that the above numbers are provided to fit a specific example or case in which for each OFDM-frame, there is the associated 3744 FEC encoded symbols. But it does not mean the instant invention can only be used in 3744 symbols or some specified number of symbols. Although the numbers do dependent upon what is defined in an associated standard or what is transmitted on the transmitter side. It is comtemplated that the time-deinerleaver can be used in any convolutional deinterleavers with any value of parameters of B and M.

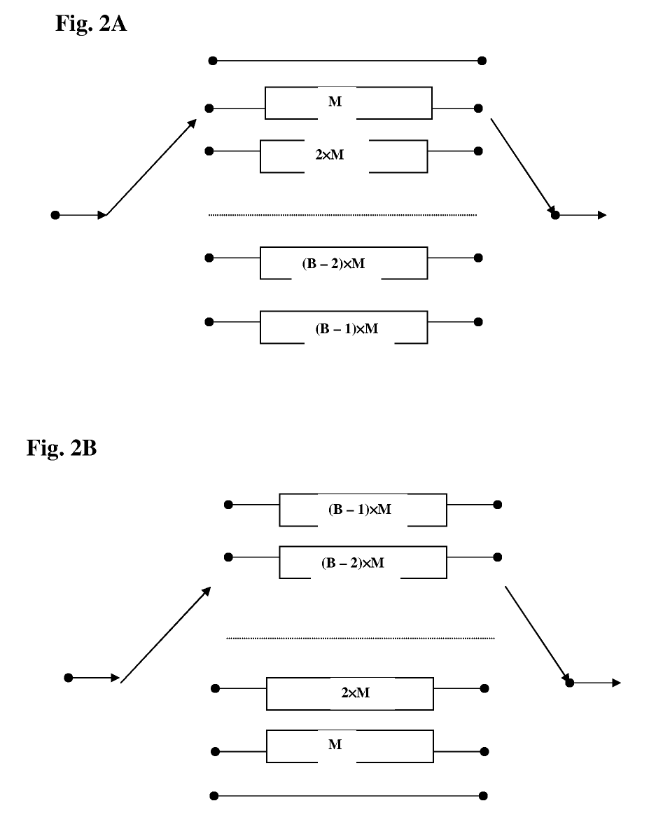

In order to shorten the frame synchronization time, a convolutional interleaver scheme is used for Time-interleaving on the transmitter side. The scheme is shown in FIGS. 2A-2B wherein a time interleaver/de-interleaver pair is depicted. In FIG. 2A the time interleaver is shown. In FIG. 2B the time de-interleaver is shown. The variable B denotes interleave width (branches) and the variable M means the interleave depth (size for delay buffers). The total delay of the interleave/de-interleave pair can be calculated from M×(B−1)×B. For the time-deinterleaver used herein, there are 3 modes used or implemented.

In Mode 1: M=48, B=52;

In Mode 2: M=240, B=52; and

In Mode 3: M=720, B=52.

As can be seen, the total time delays introduced by Time interleaver/de-interleaver pair for the three modes are respectively one hundred twenty seven thousand two hundred ninety six (127,296), six thirty six thousand four hundred eighty (636,480), and one million nine hundred and nine thousand four hundred fourth (1,909,440) symbol clock cycles.

For hardware implementation of this embodiment, the Time-Deinterleaver has fifty two (52) branches. Each of the branches has a delay line or FIFO (first in, first out) device with a different time delay. For example, for in mode 1, the bottom branch has a zero delay (as opposed to Time-Interleaver), while the top branch has a 2448-symbol clock delay. For each input valid clock cycle, one Time-Deinterleaver input data is pushed into the FIFOs from the left side, at the same time, a data is read out from the right side of the FIFOs. The sequence of the operation is as follows: the first input data is pushed into the left side of the first branch, which is the (B−1)×M FIFO. In turn, the first out data is read out from the right side of the same branch. The second data is pushed into the left side of the second branch, which is (B−2)×M FIFO. In turn, the second out data is read out from the right side of the same branch, the third . . . , etc. Because there is no time delay in the 52th branch, the input data is directly sent out without storing. Then the process goes back to first branch again and the whole process repeats itself.

Initially, before the data used by the present invention are pushed completely (all the way) into all the FIFOs, data read out are simply useless and discarded. In other words, before the 52 delay lines become all available on the right side (i.e. the first-in useful information contained within the FIFOs), data read out are simply discarded. When the data pushed into the 52 delay lines become available on the right side respectively at the right end of the FIFOs, start send out data read from the 52 delay lines (which corresponds to one hundred twenty seven thousand two hundred ninety six (127,296) clock cycle delays for mode 1; six thirty six thousand four hundred eighty (636,480) clock cycle delays for mode 2; and one million nine hundred and nine thousand four hundred fourth (1,909,440) clock cycle delays fro mode 3 respectively.

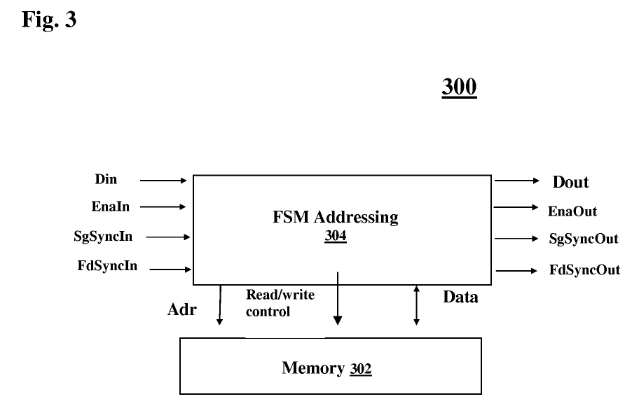

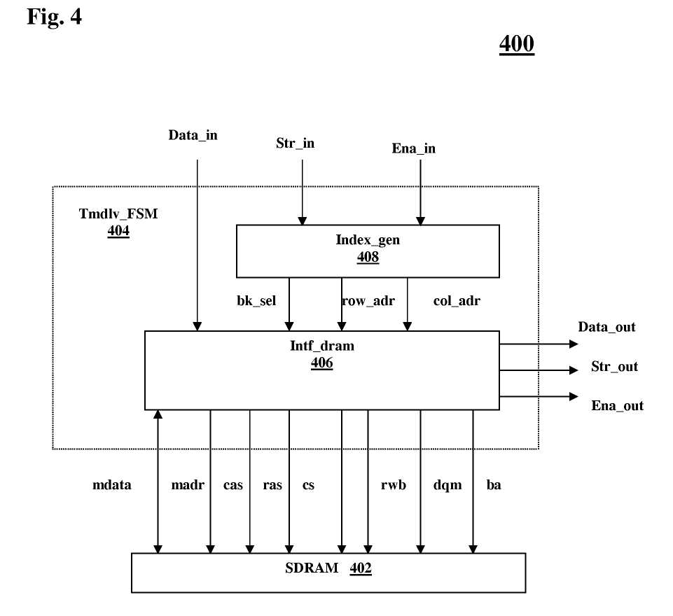

Referring to FIG. 3, in a preferred embodiment 300, instead of using fifty-one (51) separate memories to realize the 51 nonzero delay lines as shown in FIGS. 2A-2B, all of the nonzero 51 delay lines are implemented using a single piece of RAM 302. Although the single RAM 302 is used, different associated memory locations are provided therein. The addressing and FSM block 304 controls the input data, Din, and stores same to the corresponding memory location in the memory block 302. At the same time, a data in the memory is loaded to Dout as output. The total size of the memory needed are (B−1)×B×M/2×(#of Bits per symbol). For the above mentioned three (3) modes time-deinterleaver, the sizes of the memory units required are 63,648, 318,240 and 954,720 symbols respectively. For the present invention, since the data width of each symbol is either 28 bits or 24 bits, if it is required to realize all 3 modes in one piece of memory, the total memory bits required are either 22,913,280 bits or 26,732,160 bits. Referring to FIG. 4, an introduction 400 of synchronous DRAM 402 in association with a processor such as a finite state machine 404 is provided. finite state machine 404 comprises two sub-blocks, i.e., Index_gen 408 and Inft_dram 406 respectively. Index_gen 408 functions according to a pre-selected Time-Deinterleaver mode and a SDRAM memory partition. Index_gen 408 generates the bank-select (bk_sel), row address (row_adr), and column address signals for storing each input symbol into the SDRAM 402 or Read out the previous stored symbol from the SDRAM 402. The bk_sel is tuggled between “0” and “1” for neighboring input/output symbols so that the SDRAM memory access is interleaved between bank1 and bank2. For the location in the same bank, the column address is increased by 2 each time because the burst length equal to 2 setting.

intf_dram 406 functions ccording to the specific SDRAM operation timing diagram. intf_dram 406 generates the real SDRAM input control and data signals from the Time_Deintlerlever Input Data, addresses from index_gen block, and read out the data previous stored in the SDRAM to generate the final Time-Deinterleaver outputs. Data_in comprises the 24 or 28 bits time-delinterleaver input data. Ena_in functions in that when its value is high, the input data to the time-deinterleaver is valid.data. Str_in function to indicate the first valid input data of each frame (here each frame has 3744 symbols) to the time-deinterleaver. Data_out comprises the 24 or 28 bits time-deinterleaver output data. Ena_out functions in that when its value is high, the output data from the time-deinterleaver is valid.Str_out indicate the first valid output data of each frame from the time-deinterleaver.

It should be noted that any micro-controller having the requisite speed is contemplated in the present invention. To implement the Time-Deinterleaver, a single chip with 1 Meg×16×4 Banks is used. The 64 Mb single chip SDRAM 402 is a high-speed CMOS dynamic random-access memory containing 67,108,864 bits. It is internally configured as a quad-bank DRAM with a synchronous interface with all signals being registered on the positive edge of the clock signal CLK. Each bank is organized as 4096 rows by 256 columns by 16 bits. Read and write accesses to the single chip SDRAM 402 are burst oriented; accesses start at a selected location and continue for a programmed number of locations in a programmed sequence. Accesses begin with the registration of an ACTIVE command, which is then followed by a READ or WRITE command. The address bits registered coincident with the ACTIVE command are used to select the bank and row to be accessed (BA0, BA1 for selecting the bank; A0-A11 for selecting the row). The address bits registered coincident with the READ or WRITE command are used to select the starting column location for the burst access

The single chip single chip SDRAM 402 provides for programmable READ or WRITE burst lengths of 1, 2, 4, or 8 locations respectively, or for the full page, with a burst termination option. An auto pre-charge function may be enabled to provide a self-timed row pre-charge that is initiated at the end of the burst sequence. The 64 Mb single chip SDRAM 402 uses an internal pipelined architecture to achieve high-speed operation. This architecture is compatible with the 2n rule of pre-fetch architectures, but it further allows the column address to be changed on every clock cycle to achieve a higher speed, that is fully random accessible. Pre-charging one bank while accessing one of the other three banks will hide the pre-charge cycles and provide seamless, high-speed, random-access operation.

The 64 Mb single chip SDRAM 402 is designed to operate in 3.3V memory systems. A set of auto refresh modes is provided, along with a power-saving, power-down mode. All inputs and outputs are LVTTL-compatible. SDRAM 402s offer substantial advances in DRAM operating performance, including the ability to synchronously burst data at a high data rate with automatic column-address generation, the ability to interleave between internal banks in order to hide pre-charge time and the capability to randomly change column addresses on each clock cycle during a burst access.

The 64 Mb single chip SDRAM 402 is adapted for memory partition and mode initialization for time-deinterleaver applications. In order to provide a seamless, high-speed, random-access operation according to a particular time-deinterleaver application, single chip SDRAM 402 is programmed as follows: Two banks of the single chip SDRAM 402 are used. All the data locations corresponding to the even branches of the Time-Deinterleaver are assigned to bank 1. All the data locations corresponding to the odd branches of the Time-Deinterleaver are assigned to bank 2. Since the Time-Deinterleaver operation sequence is started from the first branch down to the last one (For our case the operation start from branch 51 down to branch 0), by separating the neighboring branches into 2 different banks, the memory activation, and Read/Write operation are interleaved between two banks. For example, when a Read/Write operation is performed on a particular row previously activated in bank 1, one can activate a row in bank 2 for the next-step operation before waiting the pre-charge operation in bank 1 is completely accomplished. As a result, a seamless, high-speed data flow is guaranteed. The Burst Length of the single chip SDRAM 402 is programmed as 2. Burst type is sequential. Read and write accesses to the single chip SDRAM 402 are burst oriented, with the burst length being programmable. The burst length determines the maximum number of column locations that can be accessed for a given READ or WRITE command. Burst lengths of 1, 2, 4, or 8 locations are available for both sequential and the interleaved burst type.

The data-width of the Time-Deinterleaver symbols is either 24-bits or 28 bits. However the data-width is only 16 bits. To make the time-deintlerlever work along with the single chip SDRAM 402, the burst length is programmed to 2, and the burst type is sequential. Each Time-Deinterlever data symbol is divided into 2 parts, the first part corresponds to the first 12 (bit[23:12]) or 14 (bit[27:14]) MSBs of the symbol. The second part corresponds to the last 12 (bit[11:0]) or 14 (bit[13:0]) LSBs. The MSB part is allocated to burst 1 location. The LSB part is allocated to burst 2 location.

The CAS latency is set to 2. The CAS latency is the delay, in clock cycles, between the registration of a READ command and the availability of the first piece of output data. The latency can be set to two or three clocks. The CAS latency is set to 2 in order to fit our clock speed and scheduling requirements.

The Read command is using Read-Without Auto Precharge. Since for the same memory location, one will first read out the previously stored data, then write the new input data in, each Read command is followed by a Write command, The corresponding row should be kept open until Write operation is finished.

The Write command is using Write-With Auto Precharge. After written the new data into the selected location, the operation on current row is finished. One need to close (pre-charge) the current row and switch to another row in another bank, so that a White with Auto Prechange is used to hide the pre-charge time.

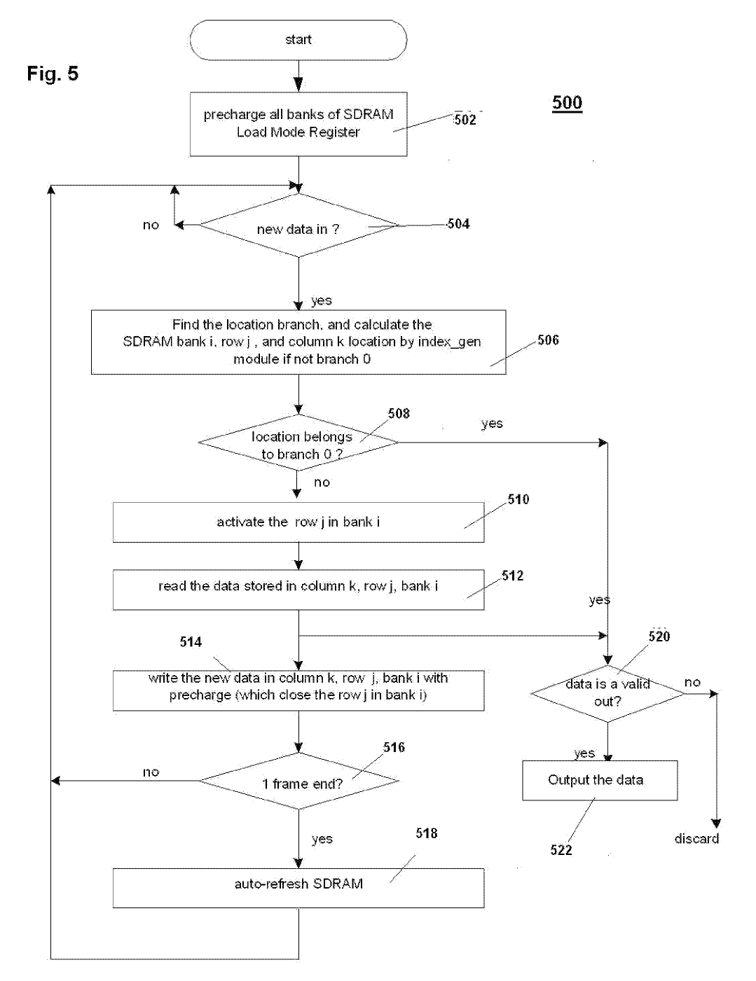

Referring to FIG. 5, a flowchart 500 of the present invention is depicted. Precharge all banks of single chip SDRAM and load mode register (Step 502). Determine whether there is new input data to the time-deinterleaver (Step 504). If there is new data, find the location brach, and caldulate the single chip SDRAM bank i, row j, and column k location by index_gen 408 module; and if not branch 0 (Step 506). In other words, in Step 506 zero-delay branch is not stored, since the invention teaches only storing data corresponding to nonzero-delay branches. Therefore, one only need to calculate bank i, row j and column k location for nonzero-delay branch. Further, if there is not new data, repeat step 504. Determine if the branch belongs to branch 0 (Step 508). If the branch does not belong to branch 0, row j in bank i is activated (Step 510). Data stored in column k, rowj, bank i is read (Step 512). New data are written to colukn k, row j, bank i with precharge which closes (turn-off) the row j in bank depending upon whichever is closer to row j in bank i (Step 514). Determine whether the frame end is reached (Step 516). If the frame end is not reached, revert back to the beginning of Step 504. If the frame end is reached, automatically refresh the single chip SDRAM and revert back to the beginning of Step 504 (Step 518). Going back now to step 508, if it is true that the location does belong to branch 0, a determination is made as to whether the data out is valid data (Step 520). If the data out is valid data, use the data as output (Step 522). If the data out is not valid data, discard same. The step 520 also determines whether the read data from step 512 is valid or not.

It is noted that the present invention contemplates using the PN sequence disclosed in U.S. Pat. No. 7,072,289 to Yang et al which is hereby incorporated herein by reference.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to close ended or limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

We claim:

1. An apparatus comprising:
a processor for processing interleaved data; and
an independent memory coupled to the processor for processing the interleaved data.

2. The apparatus of claim 1, wherein the apparatus comprises a Time-Deintleaver.

3. The apparatus of claim 1, wherein the processor comprises a finite state machine.

4. The apparatus of claim 1, wherein the independent memory comprises a single chip memory.

5. The apparatus of claim 1, wherein the independent memory comprises a single chip SDRAM.

6. A receiver comprising:
an apparatus having a processor for processing interleaved data; and
an independent memory coupled to the processor for processing the interleaved data.

7. The receiver of claim 6, wherein the apparatus comprises a Time-Deintleaver.

8. The receiver of claim 6, wherein the processor comprises a finite state machine.

9. The receiver of claim 6, wherein the independent memory comprises a single chip memory.

10. The receiver of claim 6, wherein the independent memory comprises a single chip SDRAM.

11. The receiver of claim 6, wherein the receiver comprises an Orthogonal Frequency Division Multiplexing (OFDM) receiver.

12. The receiver of claim 6, wherein the receiver comprises a Time Domain Synchronous Orthogonal Frequency Division Multiplexing (TDS-OFDM) receiver.

13. The receiver of claim 6, wherein the receiver comprises a low-density parity-check (LDPC) based TDS-OFDM receiver.
